(19) United States
(12) Patent Application Publication
(10) Pub. No.: US 2026/0283328 A1
(43) Pub. Date: Sep. 24, 2026

(54) RAZOR CLEANING AND MAINTAINING APPARATUS

(71) Applicant: blackparrot lnc., Seoul (KR)

(72) Inventors: Seung-ryul NOH, Seoul (KR); Byeong-hwi AHN; Kyu-in SHIM

(73) Assignee: blackparrot lnc., Seoul (KR)

(21) Appl. No.: 19/296,604

(22) Filed: Aug. 11, 2025

(30) Foreign Application Priority Data
Mar. 18, 2025 (KR) 10-2025-0034445
Apr. 3, 2025 (KR) 10-2025-0043321

(51) Int. Cl. A45D 27/46

(52) U.S. Cl. CPC A45D 27/46

(57) ABSTRACT

A razor cleaning and maintaining apparatus is provided. A razor cleaning and maintaining apparatus, comprising: a body part in which a central hole is formed to pass through an inside of the body part and which comprises a coupling jaw formed along an inner circumferential surface; a head part which is coupled to a top of the body part and in which a head hole connected to the central hole and passing through an inside of the head part is formed; a cleaning part comprising a first outer peripheral surface and a second outer peripheral surface; a water tank part disposed to be housed the inside of the body part and having a protruding part formed to protrude outward from an upper part so as to be caught by the coupling jaw; a waterproof tape; and a control part.

### CROSS-REFERENCE TO RELATED APPLICATION

This application claims priority under 35 U.S.C § 119 to Korean Patent Application No. 10-2025-0034445 filed on Mar. 18, 2025, and Korean Patent Application No. 10-2025-0043321 filed on Apr. 3, 2025, in the Korean Intellectual Property Office, the entire contents of which are hereby incorporated by reference.

### BACKGROUND

### Technical Field

The disclosure relates to a razor cleaning and maintaining apparatus. In particular, the disclosure relates to a razor cleaning and maintaining apparatus that removes residues left after using a razor and maintains the hygienic condition of the razor.

### Description of the Related Art

The content set forth in this section merely provides background information on the present embodiments and does not constitute prior art.

Dead skin cells, beard residue, and moisture left on a razor provide an environment conducive to the growth of bacteria and fungi on the razor. Accordingly, the user's skin may develop skin trouble and inflammation, including bacterial infections, during the shaving process due to the residues left behind from the previous shaving.

In addition, the sharpness of the razor blades may quickly deteriorate due to residues left on the razor blades and may thus cause skin irritation. Accordingly, the replacement cycle of the razor blades gets shortened, which inevitably increases maintenance costs.

Therefore, razors must be cleaned and maintained so as not to result in residues left after shaving.

### BRIEF SUMMARY

Razor blades are often arranged with very narrow gaps to ensure close contact with the skin. However, such configurations can allow shaving residues to become deeply lodged between the blades, making them difficult to remove through rinsing with water alone.

These residues, which may include beard stubble, dead skin cells, and skin oils, tend to be viscous and firmly adhere to the surfaces of the blades. As a result, they are not easily washed away using running water, presenting challenges in maintaining blade cleanliness.

Accordingly, various embodiments of the present disclosure are directed to an apparatus and method configured to clean such residues by considering the structural characteristics of razor blades, thereby improving user convenience and hygiene.

Various embodiments of the present disclosure provide a razor cleaning and maintaining apparatus that cleans and maintains a razor by removing residues left on razor blades by physical and non-physical methods.

The technical benefits of the present disclosure are not limited to the benefits mentioned above, and other advantages of the present disclosure that have not been mentioned can be understood by the following description and will be more clearly understood by the embodiments of the present disclosure. Furthermore, it will be readily appreciated that the objects and advantages of the present disclosure can be realized by the means set forth in the claims and combinations thereof.

According to some aspects of the disclosure, a razor cleaning and maintaining apparatus, comprising: a body part in which a central hole is formed to pass through an inside of the body part and which comprises a coupling jaw formed along an inner circumferential surface; a head part which is coupled to a top of the body part and in which a head hole connected to the central hole and passing through an inside of the head part is formed; a cleaning part comprising a first outer peripheral surface and a second outer peripheral surface, wherein a plurality of projections are formed on the first outer peripheral surface so as to protrude and the plurality of projections are spaced apart from each other, and the second outer peripheral surface is in close contact with an inner surface of the head part; a base part coupled to a bottom of the body part; a water tank part disposed to be housed the inside of the body part and having a protruding part formed to protrude outward from an upper part so as to be caught by the coupling jaw; a waterproof tape disposed between the coupling jaw of the body part and the protruding part of the water tank part; and a control part disposed between the base part and the water tank part and configured to control ultrasonic vibrations generated inside the water tank part.

According to some aspects, wherein a diameter of a hole defined by the coupling jaw is formed larger than a diameter of the water tank part, the diameter of the water tank part is formed larger than a lower diameter of the head hole, and a part of a bottom of the head part is housed inside the water tank part.

According to some aspects, wherein the head part comprises a stepped part formed at the bottom of the head part, the stepped part is coupled to an inner top of the body part and an upper part of the water tank part, and the protruding part of the water tank part is disposed between the stepped part and the coupling jaw.

According to some aspects, wherein the head part comprises a first support part formed in protrusion on the inner surface of the head part in a first direction passing through the inside of the head part, and a second support part formed in protrusion on the inner surface of the head part so as to cover a part of the head hole in a second direction intersecting the first direction, and the cleaning part comprises a receiving groove formed concavely inward on the second outer peripheral surface in a form that allows coupling to the first support part and the second support part.

According to some aspects, wherein the receiving groove comprises a first receiving groove formed in a shape corresponding to an outer shape of the first support part, and a second receiving groove formed in a shape corresponding to an outer shape of the second support part, and the cleaning part is brought into close contact with an inner circumferential surface of the head part by an external force provided from an outside based on a first coupling between the first support part and the first receiving groove and a second coupling between the second support part and the second receiving groove.

According to some aspects, further comprising: a charging hole formed in one of the body part and the base part, wherein the control part comprises a battery and a charging socket, and the charging socket is coupled to the charging hole.

According to some aspects of disclosure, a razor cleaning and maintaining apparatus, comprising: a head part in which a head hole passing through an inside of the head part is formed and which comprises a first support part formed in protrusion on an inner surface of the head part in a first direction passing through the inside of the head part and a second support part formed in protrusion on the inner surface of the head part so as to cover a part of the head hole in a second direction intersecting the first direction; a cleaning part comprising a first outer peripheral surface and a second outer peripheral surface, wherein a plurality of projections are formed on the first outer peripheral surface so ad to protrude and the plurality of projections are spaced apart from each other and, the second outer peripheral surface is in close contact with the inner surface of the head part, and a receiving groove formed concavely inward on the second outer peripheral surface in a form that allows coupling to the first support part and the second support part; and a body part coupled to the head part and having a water tank part inside of which ultrasonic waves are generated.

According to some aspects, wherein the head hole formed in the head part is formed so that a cross-sectional area gets smaller as the head hole approaches the body part, and the first outer peripheral surface is formed in a shape of a part of a streamlined shape.

According to some aspects, wherein the first support part comprises a plurality of pillars formed on one surface of the second support part and spaced apart from each other, and each of the pillars is formed to be connected to the inner surface of the head part.

According to some aspects, wherein one end of the pillar is connected to the first support part, and the other end of the pillar is formed to have a step relative to a middle part of the pillar.

According to some aspects, wherein, the plurality of projections formed on the first outer peripheral surface comprises an upper projection group, a middle projection group and a lower projection group, the upper projection group disposed in an upper part of the cleaning part and the lower projection group disposed in a lower part of the cleaning part are formed so that a height or thickness is different from each other between adjacent projections, and the middle projection group disposed in a middle part of the cleaning part is formed so that a height difference or thickness difference between adjacent projections is smaller compared to the upper projection group and the lower projection group.

The razor cleaning and maintaining apparatus of the present disclosure can improve the hygiene of the razor blades by first removing the residue on the razor blades with physical cleaning and secondly removing the fine residue and bacteria on the razor blades with non-physical cleaning including ultrasonic waves to hygienically remove the residue on the razor blades, and thereby, can maintain the sharpness of the razor blades for a long time as the cleaning efficiency of the razor increases and can extend the service life of the razor by slowing down the rate of wear and corrosion of the razor blades.

If devices employ ultrasonic cleaning alone, they tend to fail in the initial removal of larger debris particles, which results in inefficient cleaning when thick residues block ultrasonic wave transmission. If devices use only mechanical cleaning elements, they cannot eliminate microscopic bacteria and fine particles that remain after physical cleaning. Existing solutions fundamentally suffer from relying on a single cleaning mechanism, either physical or non-physical, which fails to address the full range of contaminants from large debris to microscopic bacteria.

Furthermore, the razor cleaning and maintaining apparatus can effectively protect the skin health of the user by minimizing the risk of skin infection, inflammation, and trouble of the user by completely removing germs, bacteria, and contaminants formed on the razor blades.

Moreover, the razor cleaning and maintaining apparatus can provide the user with the ease of maintaining the razor by minimizing the additional effort of the user for razor maintenance.

In addition to the foregoing description, specific effects of the present disclosure will be stated together while describing specific details for implementing the present disclosure below.

### BRIEF DESCRIPTION OF THE SEVERAL VIEWS OF THE DRAWINGS

FIG. 1 is a perspective view of a razor cleaning and maintaining apparatus according to some embodiments of the present disclosure.

FIG. 2 is a front view and a rear view of the razor cleaning and maintaining apparatus of FIG. 1.

FIG. 3 is a side view of a handle of the razor cleaning and maintaining apparatus of FIG. 1.

FIG. 4 is a plan view and a bottom view of the handle of the razor cleaning and maintaining apparatus of FIG. 1.

FIG. 5 is an exploded perspective view of the razor cleaning and maintaining apparatus of FIG. 1.

FIG. 6 is a cross-sectional view of the body part of FIG. 5.

FIG. 7 is a diagram for describing the head part of FIG. 5.

FIGS. 8 to 10 are diagrams for describing the cleaning part of FIG. 5.

FIG. 11 is a diagram for describing the coupling between the head part and the cleaning part of FIG. 5.

FIG. 12 is a diagram for describing the principle of forces applied to the cleaning part coupled to the head part of FIG. 11 according to the first cleaning of the razor.

FIGS. 13 and 14 are diagrams for describing a part of the cross-section of FIG. 1.

FIG. 15 is an enlarged view of C in FIG. 14.

FIG. 16 is a diagram for describing a razor cleaning method based on the cross-sectional view of FIG. 1.

### DETAILED DESCRIPTION

The terms or words used in the disclosure and the claims should not be construed as limited to their ordinary or lexical meanings. They should be construed as the meaning and concept in line with the technical idea of the disclosure based on the principle that the inventor can define the concept of terms or words in order to describe his/her own inventive concept in the best possible way. Further, since the embodiment described herein and the configurations illustrated in the drawings are merely one embodiment in which the disclosure is realized and do not represent all the technical ideas of the disclosure, it should be understood that there may be various equivalents, variations, and applicable examples that can replace them at the time of filing this application.

The shapes, sizes, dimensions (e.g., length, width, height, thickness, radius, diameter, area, etc.), ratios, angles, number of elements, and the like illustrated in the accompanying drawings for describing the embodiments of the present disclosure are merely examples, and the present disclosure is not limited thereto.

A dimension including size and a thickness of each component illustrated in the drawing are illustrated for convenience of description, and the present disclosure is not limited to the size and the thickness of the component illustrated, but it is to be noted that the relative dimensions including the relative size, location, and thickness of the components illustrated in various drawings submitted herewith are part of the present disclosure.

Although terms such as first, second, A, B, etc., used in the description and the claims may be used to describe various components, the components should not be limited by these terms. These terms are only used to differentiate one component from another. For example, a first component may be referred to as a second component, and similarly, a second component may be referred to as a first component, without departing from the scope of the disclosure. The term ‘and/or’ includes a combination of a plurality of related listed items or any item of the plurality of related listed items.

The terms used in the description and the claims are merely used to describe particular embodiments and are not intended to limit the disclosure. Singular forms are intended to include plural forms unless the context clearly indicates otherwise. In the application, terms such as “comprise,” “comprise,” “have,” etc., should be understood as not precluding the possibility of existence or addition of features, numbers, steps, operations, components, parts, or combinations thereof described herein.

Unless otherwise defined, the phrases “A, B, or C,” “at least one of A, B, or C,” or “at least one of A, B, and C” may refer to only A, only B, only C, both A and B, both A and C, both B and C, all of A, B, and C, or any combination thereof.

As used herein, the term “connected” is intended to have the broadest possible meaning. Specifically, the phrase “A is connected to B” encompasses both a direct connection—where no intervening components or elements are present—and an indirect connection, where one or more intermediate components or elements exist between A and B. In other words, “A is connected to B” includes both direct physical or electrical coupling and indirect coupling through one or more intervening components. Unless explicitly stated otherwise, these terms do not require direct physical or electrical contact. The term “coupled” and “in contact” should be interpreted in the same manner.

Unless being defined otherwise, all terms used herein, including technical or scientific terms, have the same meaning as commonly understood by those skilled in the art to which the disclosure pertains.

Terms such as those defined in commonly used dictionaries should be construed as having a meaning consistent with the meaning in the context of the relevant art, and are not to be construed in an ideal or excessively formal sense unless explicitly defined in the application. In addition, each configuration, procedure, process, method, or the like included in each embodiment of the disclosure may be shared to the extent that they are not technically contradictory to each other.

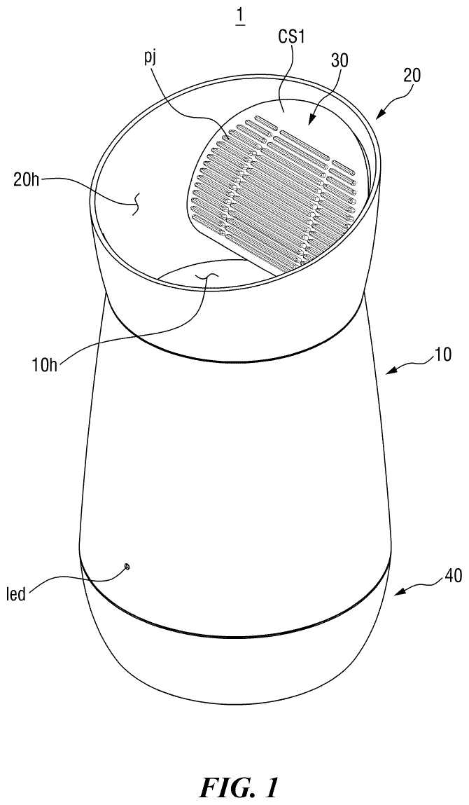

Hereinafter, a razor cleaning and maintaining apparatus according to some embodiments of the present disclosure will be described in detail with reference to FIGS. 1 to 16.

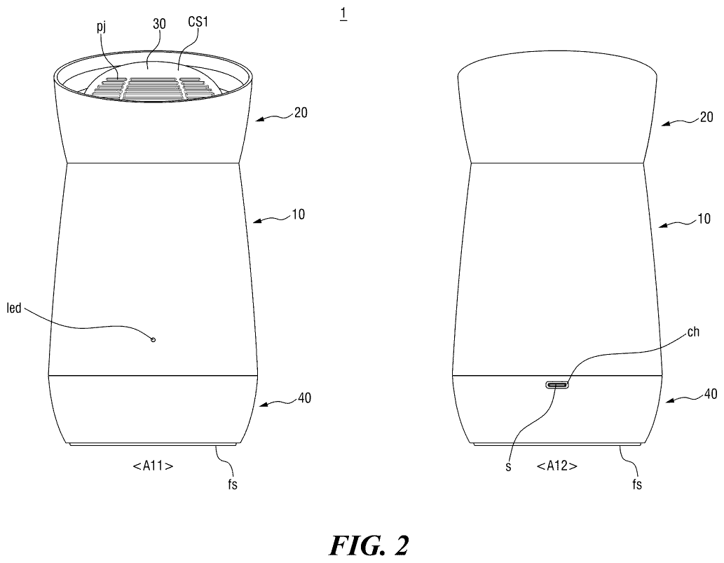

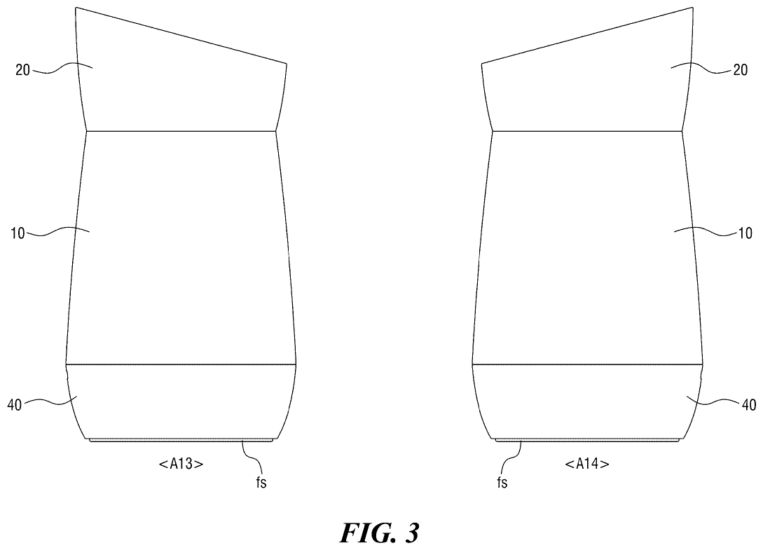

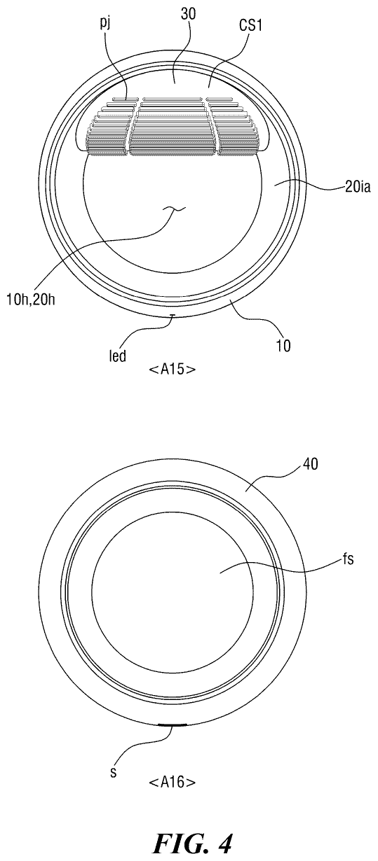

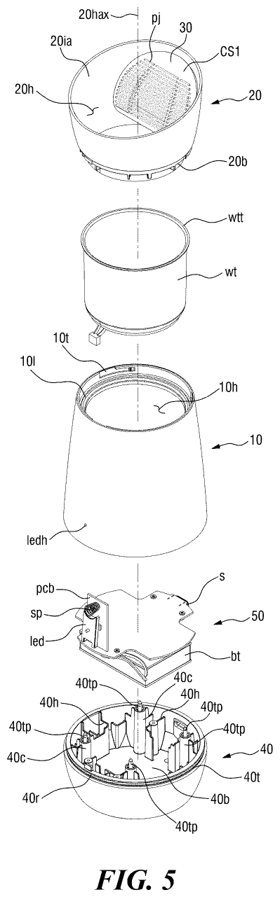

FIG. 1 is a perspective view of a razor cleaning and maintaining apparatus according to some embodiments of the present disclosure. FIG. 2 is a front view and a rear view of the razor cleaning and maintaining apparatus of FIG. 1. FIG. 3 is a side view of a handle of the razor cleaning and maintaining apparatus of FIG. 1. FIG. 4 is a plan view and a bottom view of the handle of the razor cleaning and maintaining apparatus of FIG. 1. FIG. 5 is an exploded perspective view of the razor cleaning and maintaining apparatus of FIG. 1.

Referring to FIGS. 1 to 5, a razor cleaning and maintaining apparatus 1 may include a body part 10, a head part 20, a cleaning part 30, a base part 40, a water tank part wt, and a control part 50.

In the body part 10, a central hole 10h passing through the inside may be formed. In this case, the body part 10 may include a coupling jaw 10l formed along the inner circumferential surface of the body part 10.

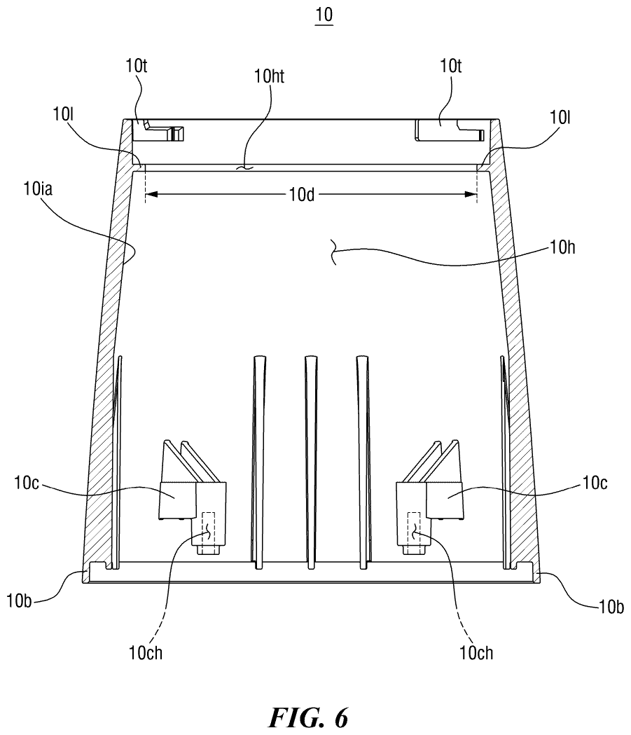

FIG. 6 is a cross-sectional view of the body part of FIG. 5.

Referring to FIG. 6 together, the body part 10 may include the coupling jaw 10l formed in protrusion along the inner circumferential surface 10ia of the body part 10. For example, the coupling jaw 10l may be coupled to the water tank part wt housed inside the body part 10.

The water tank part wt may be formed in a concave shape and may include a protruding part wtt formed by protruding outward from the upper part. For example, the water tank part wt may be disposed so as to be housed inside the body part 10 by passing through the central hole 10h of the body part 10 in the direction from the top 10t to the bottom 10b of the body part 10. The water tank part wt may be housed inside the body part 10 and coupled to the body part 10 by having the protruding part wtt caught on the coupling jaw 10l.

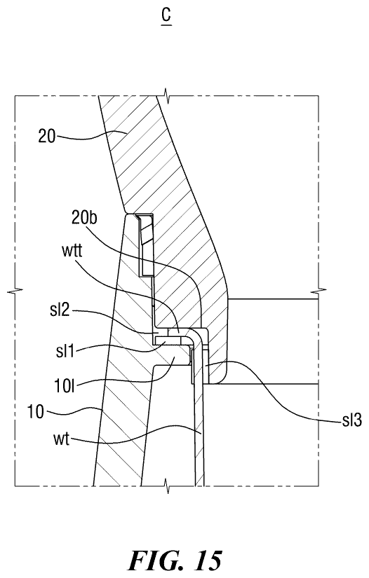

The water tank part wt may pass through the central hole 10h of the body part 10 in the direction from the top 10t to the bottom 10b of the body part 10, and the upper part of the water tank part wt may be caught on the coupling jaw 10l and may thus be coupled to the body part 10. The structure of the body part 10, the coupling jaw 10l, and the water tank part wt will be described in detail later with reference to FIG. 15.

The bottom 10b of the body part 10 may be coupled to the base part 40. The body part 10 may include at least one connecting part 10c formed by a part of the inner circumferential surface 10ia between the coupling jaw 10l and the bottom 10b being protruded. For example, the connecting part 10c may include a connecting groove 10ch in a concave form. The body part 10 may be coupled stably to the base part 40 based on the coupling between the bottom 10b of the body part 10 and the base part 40 and the coupling between the connecting part 10c and the base part 40 using a connecting medium.

Referring again to FIGS. 1 to 5, the head part 20 may be coupled to the top 10t of the body part 10. The head part 20 may have a head hole 20h formed therein, which is connected to the central hole 10h of the body part 10 and passes through the inside of the head part 20. For example, the central axis 20hax passing through the center of the head hole 20h may coincide with the central axis of the central hole 20h.

In addition, the head hole 20h may be formed so that its cross-sectional area gets smaller as it approaches the body part 10.

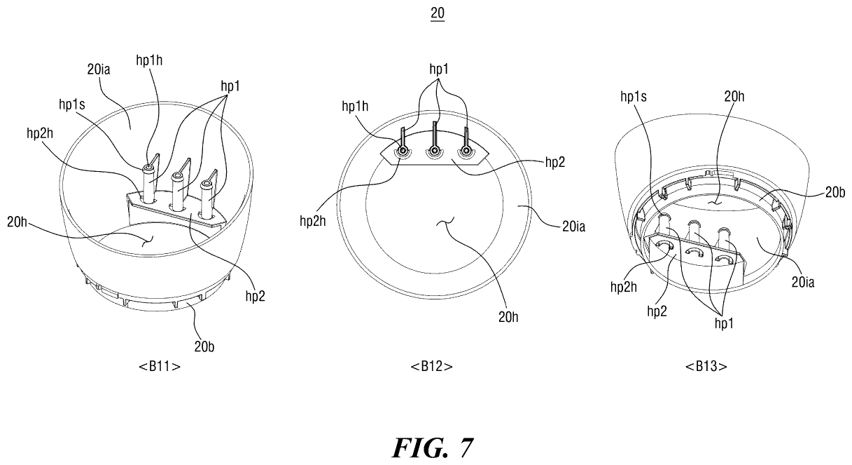

FIG. 7 is a diagram for describing the head part of FIG. 5. <B11> in FIG. 7 is a perspective view of the head part 20. <B12> in FIG. 7 is a plan view of the head part 20. <B13> in FIG. 7 is a perspective view of the head part 20 corresponding to the direction of an inner surface 20ia of the head part 20 at the bottom of the head part 20.

Referring to FIG. 7 together, the head part 20 may include a stepped part 20b formed at the lower part. The stepped part 20b may be coupled to the inner top 10t of the body part 10 and the upper part of the water tank part wt. Further, a part of the stepped part 20b may be housed inside the water tank part wt coupled to the body part 10 by getting caught on the coupling jaw 10l. The protruding part wtt of the water tank part wt may be disposed between the stepped part 20b and the coupling jaw 10l. The organic coupling between the body part 10, the coupling jaw 10l, and the water tank part wt will be described in detail later with reference to FIG. 15.

The head part 20 may include at least one first support part hp1 and a second support part hp2 formed in protrusion on the inner surface 20ia. For example, the first support part hp1 may be formed in protrusion on the inner surface 20ia in a first direction passing through the inside of the head part 20.

The first support part hp1 may include a plurality of pillars spaced apart from each other. For example, each pillar may have a support groove hp1h formed therein.

Each pillar may be formed to be connected to the inner surface 20ia of the head part 20. In this case, one end of each pillar may be formed on one surface of the second support part hp2 and connected to the second support part hp2. The other end of each pillar may be formed to have a step hp1s relative to the middle part of the pillar.

The second support part hp2 may be formed in protrusion on the inner surface 20ia so as to cover a part of the head hole 20h in a second direction intersecting the first direction. The second support part hp2 may include a support hole hp2h formed in correspondence at a position for connection to the first support part hp1.

Next, referring again to FIGS. 1 to 5, the cleaning part 30 may be coupled to the inner surface 20ia of the head part 20.

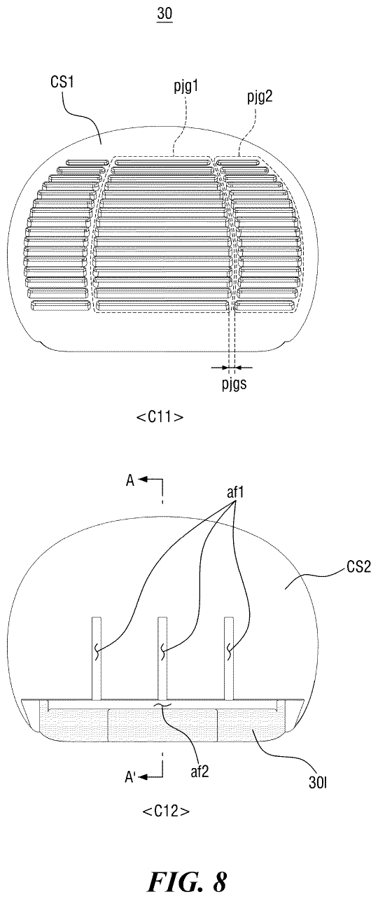

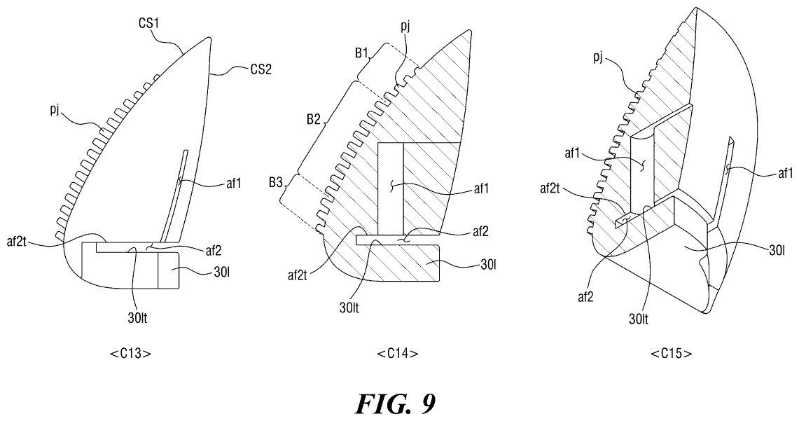

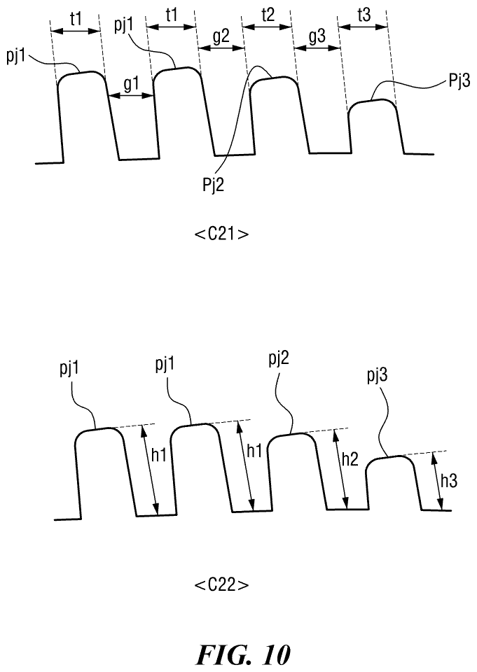

FIGS. 8 to 10 are diagrams for describing the cleaning part of FIG. 5. <c11> in FIG. 8 is a front view of the cleaning part 30. <c12> in FIG. 8 is a rear view of the cleaning part 30. <c13> in FIG. 9 is a side view of the cleaning part 30. <c14> in FIG. 9 is a cross-sectional view of the cleaning part 30 taken along the line A-A′ of <c12> in FIG. 8. <c15> of FIG. 9 is a perspective view of the cleaning part 30 taken along the line A-A′ of <c12> in FIG. 8. FIG. 10 is a diagram for describing the projections pj of <c14> in FIG. 9.

Referring to FIGS. 8 and 9 together, the cleaning part 30 may include a first outer peripheral surface CS1 on which a plurality of projections pj formed in protrusion spaced apart from each other is formed, and a second outer peripheral surface CS2 in close contact with the inner surface 20ia of the head part 20. For example, the first outer peripheral surface CS1 may be formed in the shape of a part of a streamlined shape. The first outer peripheral surface CS1 may be formed as a surface corresponding to a curved shape that gets closer to the central axis 20hax of the head hole 20 as it approaches the body part 10. Further, the first outer peripheral surface CS1 may be formed in a curved shape corresponding to the shape of an external part of a bamboo hat. However, this description is merely illustrative, and the embodiments of the present disclosure are not limited thereto.

The plurality of projections pj may include a first group of projections pjg1 and a second group of projections pjg2. For example, the first group of projections pjg1 and the second group of projections pjg2 may be arranged spaced apart from each other by a preset group gap pjgs.

In addition, the first group of projections pjg1 and the second group of projections pjg2 may include an upper projection group B1 present in the upper part of the cleaning part 30, a lower projection group B3 present in the lower part of the cleaning part 30, and a middle projection group B2 present in the middle of the cleaning part 30, respectively.

For example, the upper projection group B1 and the lower projection group B3 may be formed so that the heights or thicknesses are different from each other between adjacent projections. Each projection of the upper projection group B1 and the lower projection group B3 may be formed so that the height or thickness increases or is maintained as it approaches the middle of the cleaning part 30. The middle projection group B2 may be formed so that the height difference or thickness difference between adjacent projections is smaller or maintained compared to the upper projection group B1 and the lower projection group B3.

Furthermore, the plurality of projections pj may be formed taking into account a ratio calculated based on the thickness and height of the projections, and gaps between the projections. For convenience of description, an embodiment of a first projection, a second projection, and a third projection included in the upper projection group B1 will be described as an example with reference to FIG. 10 together.

Referring to FIG. 10 together, the second projection pj2 may be disposed between the first projection pj1 and the third projection pj3. The first projection pj1 may be a projection formed by the first outer peripheral surface CS1 projecting with a first height h1 and a first thickness t1. The second projection pj2 may be a projection formed by the first outer peripheral surface CS1 projecting with a second height h2 and a second thickness t2. The third projection pj3 may be a projection formed by the first outer peripheral surface CS1 projecting with a third height h3 and a third thickness t3.

In addition, the first projection pj1 may be a plurality of projections formed by the first outer peripheral surface CS1 projecting with the first height h1 and the first thickness t1 in a direction facing away from the second projection pj2.

For convenience of description, the separation distance between the projections of the first projection pj1 is defined as a first gap g1. The separation distance between the first projection pj1 and the second projection pj2 is defined as a second gap g2. The separation distance between the second projection pj2 and the third projection pj3 is defined as a third gap g3.

The plurality of projections pj may be formed in a shape in which the ratio calculated based on the thickness and height of the projections and gaps between the projections falls within a predetermined ratio interval. For example, a first gap ratio of the first height h1 and the first gap g1, a second gap ratio of the second height h2 and the second gap g2, and a third gap ratio of the third height h3 and the third gap g3 may fall within a predetermined first ratio interval.

In addition, a first brush ratio of the first thickness t1 and the first height h1, a second brush ratio of the second thickness t2 and the second height h2, and a third brush ratio of the third thickness t3 and the third height h3 may fall within a predetermined second ratio interval.

The first ratio interval and the second ratio interval may be the same, but may be set differently depending on the embodiment as well.

Referring again to FIGS. 8 and 9, the second outer peripheral surface CS2 of the cleaning part 30 may be formed in a shape that allows coupling to the first support part hp1 and the second support part hp2 of the head part 20.

For example, the second outer peripheral surface CS2 may include a receiving groove formed concavely inward. The receiving groove may include a first receiving groove af1 that makes a first coupling to the first support part hp1 and a second receiving groove af2 that makes a second coupling to the second support part hp2.

The first receiving groove af1 may be formed in a shape corresponding to the outer shape of the first support part hp1. That is, the second outer peripheral surface CS2 may include the first receiving groove af1 corresponding to each pillar of the first support part hp1.

The second receiving groove af2 may be formed in a shape corresponding to the outer shape of the second support part hp2. For example, the second receiving groove af2 may include an upper side surface 30lt of the bottom 30l of the cleaning part 30, and a receiving groove surface af2t that contacts the top surface of the second support part hp2.

In addition, the second receiving groove af2 may be formed in a direction intersecting the first receiving groove af1, but may be connected to the first receiving groove af1.

The cleaning part 30 may be brought into close contact with the inner surface 20ia of the head part 20 by an external force provided from the outside based on the coupling between the receiving grooves af1 and af2 and the support parts hp1 and hp2.

In the following, the coupling between the head part and the cleaning part will be described with reference to FIGS. 7, 9, 11, and 12.

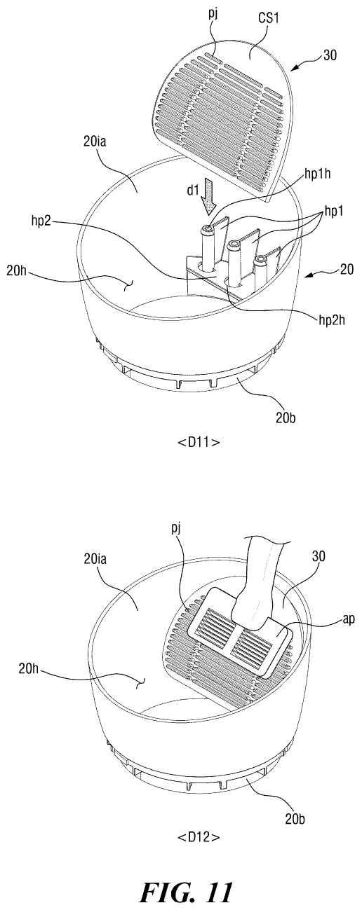

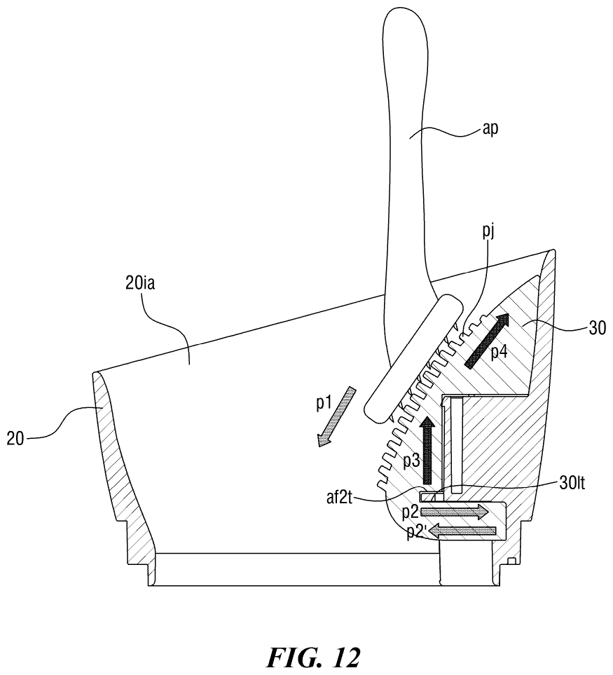

FIG. 11 is a diagram for describing the coupling between the head part and the cleaning part of FIG. 5. <D11> in FIG. 11 is a diagram for describing the process of coupling the head part and the cleaning part. <D12> in FIG. 11 is a diagram for describing a first cleaning of a razor in a state where the head part and the cleaning part are coupled. FIG. 12 is a diagram for describing the principle of forces applied to the cleaning part coupled to the head part of FIG. 11 according to the first cleaning of the razor.

Referring to FIG. 11, the cleaning part 30 may be coupled to the head part 20 by passing through the head hole 20h of the head part 20 in a first direction d1.

Referring to FIGS. 7 and 9 together, the cleaning part 30 may be coupled to the head part 20 based on a first coupling between the first support part hp1 of the head part 20 and the first receiving groove af1 and a second coupling between the second support part hp2 of the head part 20 and the second receiving groove af2.

A user may proceed with the physical cleaning of a razor ap by bringing the razor ap to be cleaned into contact with the projections pj of the cleaning part 30.

Referring to FIG. 12 together, the user may place the razor ap in contact with the plurality of projections pj of the first outer peripheral surface CS1 and provide a first external force p1 to the razor ap so that the razor ap moves in a direction closer to the body part 10 along the first outer peripheral surface CS1.

Next, a second external force p2 may be generated on the bottom 30l of the cleaning part 30 disposed below the second receiving groove af2 by the first external force p1 provided by the user. The second external force p2 may act in the direction of the inner surface 20ia of the head part 20 in the cleaning part 30.

At this time, an external force p2′ reacted to the second external force p2 may be generated on the bottom 30l of the cleaning part 30 by the elastic force of the cleaning part 30.

Next, the direction of the reacted external force p2′ may be changed by the principle of a lever. For example, the reacted external force p2′ may be transmitted as a third external force p3 and a fourth external force p4 based on the receiving groove surface af2t in contact with the top surface of the second support part hp2. That is, the first external force p1 provided by the user along the first outer peripheral surface CS1 may be changed into the third external force p3 and the fourth external force p4 directed from the cleaning part 30 toward the head part 20, with the receiving groove surface af2t in contact with the top surface of the second support part hp2 as a starting point. Thereby, the cleaning part 30 can be brought into close contact with the inner surface 20ia of the head part 20 by the external force for cleaning the razor ap.

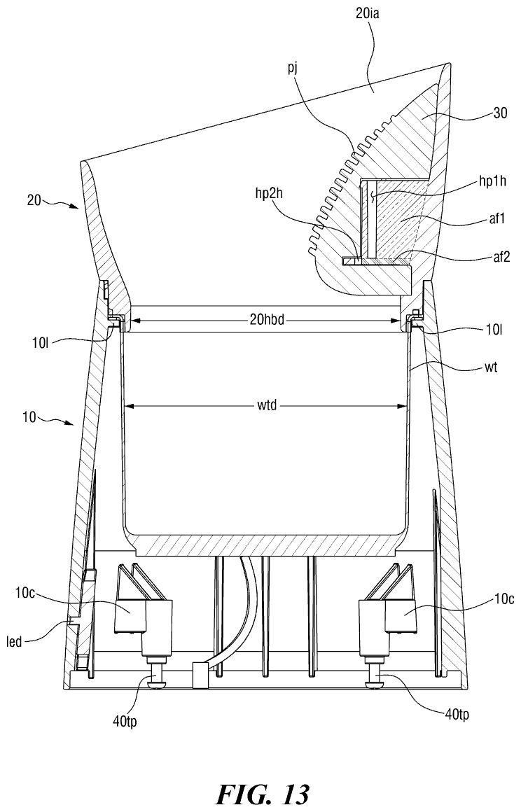

In the following, a waterproof function of the razor cleaning and maintaining apparatus will be described based on the structure of the body part 10, the head part 20, and the water tank part wt with reference to FIGS. 13 to 15.

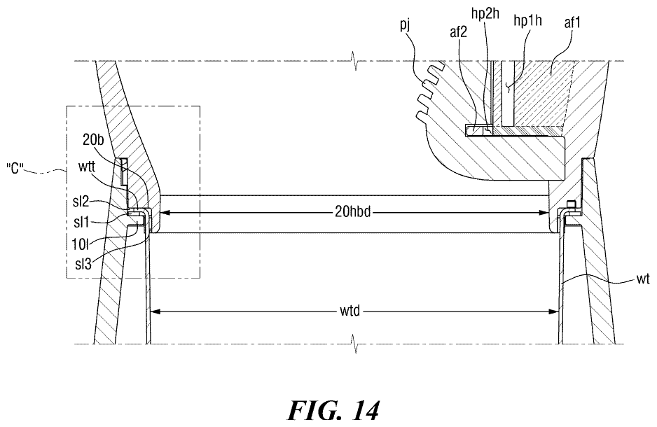

FIGS. 13 and 14 are diagrams for describing a part of the cross-section of FIG. 1. FIG. 15 is an enlarged view of C in FIG. 14.

Referring to FIGS. 6, 13, and 14, the razor cleaning and maintaining apparatus 1 has a primary waterproof effect against the liquid w contained in the water tank part wt based on the respective diameters of the body part 10, the head part 20, and the water tank part wt.

The diameter 10d of a hole 10ht defined by the coupling jaw 10l of the body part 10 may be formed to be larger than the diameter wtd of the water tank part wt. The water tank part wt may be placed so that the protruding part wtt is caught by the coupling jaw 10l, and may thus be housed inside the body part 10.

In addition, the diameter wtd of the water tank part wt may be formed to be larger than the lower diameter 20hbd of the head hole 20h. Therefore, a part of the bottom 20b of the head part 20 may be housed inside the water tank part wt by the coupling between the head part 20 and the top 10t of the body part 10.

Thereby, the razor cleaning and maintaining apparatus 1 has an effect that the liquid w does not leak out of the water tank part wt even if a flow of the liquid w contained inside the water tank part wt occurs.

Furthermore, referring to FIG. 15 together, the razor cleaning and maintaining apparatus 1 may include a waterproof tape. For example, the razor cleaning and maintaining apparatus 1 may include waterproof tapes sl1 and sl2 disposed between the coupling jaw 10l of the body part 10 and the protruding part wtt.

The waterproof tapes may include a first waterproof tape sl1 and a second waterproof tape sl2. For example, the first waterproof tape sl1 may be disposed between the coupling jaw 10l and the protruding part wtt. The second waterproof tape sl2 may be waterproof tapes disposed in each of a first separation between the inner surface 10ia of the body part 10 and the first waterproof tape sl1, a second separation between the inner surface 10ia of the body part 10 and the protruding part wtt, and a third separation between the inner surface 10ia of the body part 10 and the bottom 20b of the head part 20.

In addition, the waterproof tapes may further include a third waterproof tape sl3 disposed in a fourth separation formed between the coupling jaw 10l, the bottom 20b of the head part 20, and the water tank part wt disposed between the coupling jaw 10l and the bottom 20b of the head part 20.

Next, the base part 40 and the control part 50 of the razor cleaning and maintaining apparatus 1 will be described with reference to FIGS. 2, 4, 5, and 6.

Referring to FIGS. 2, 5, and 6, the razor cleaning and maintaining apparatus 1 may include the base part 40 that is coupled to the bottom 10b of the body part 10. For example, the base part 40 may be formed in a concave shape, and an end part 40t formed on the upper side may be coupled to the bottom 10b of the body part 10. The bottom surface of the base part 40 is the portion that the floor surface of a location where the razor cleaning and maintaining apparatus 1 is placed touches, and may include a silicone pad fs.

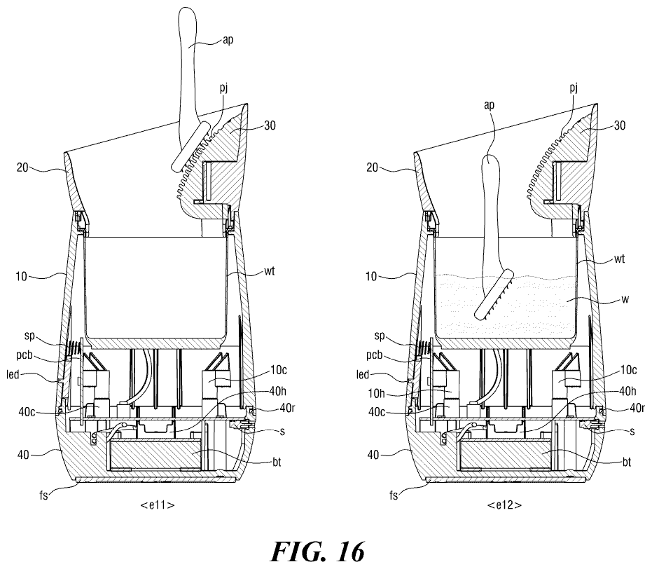

Additionally, the razor cleaning and maintaining apparatus 10 may further include a ring 40r that is coupled to the end part 40t. Referring to FIG. 16 together, the ring 40r may be disposed in a separation space created in a state where the end part 40t of the base part 40 and the bottom 10b of the body part 10 are coupled.

The base part 40 may include a base coupling part 40c having an inner surface 40b formed in protrusion therein, a base connection medium 40tp, and a base support 40h. For example, the position of the base coupling part 40c may be arranged to match the position of the connecting part 10c by the coupling between the body part 10 and the base part 40.

The base connection medium 40tp may be a fastening means that is received in the coupling part 40c and the connecting groove 10ch and firmly assembles the coupling part 40c and the connecting part 10c. For example, the base connection medium 40tp may include a fastening means such as a screw or bolt.

The base support 40h may support the control part 50 disposed between the base part 40 and the water tank part wt.

The control part 50 may be disposed between the base part 40 and the water tank part wt, but may be connected to the water tank part wt. For example, the control part 50 may be connected to the water tank part wt and control ultrasonic vibrations generated inside the water tank part wt.

The control part 50 may include a circuit board pcb, a spring sp, a battery bt, and a charging socket s.

The circuit board pcb of the control part 50 may control vibrations corresponding to ultrasonic waves in the water tank part wt by using energy provided by the battery bt charged via the charging socket s and generate ultrasonic waves in the water tank part wt. For example, the circuit board pcb may generate ultrasonic vibrations by supplying an appropriate frequency and voltage to an ultrasonic transducer.

The spring sp can apply pressure so that the ultrasonic transducer is in close contact with the surface of the water tank part wt at a constant pressure. Thereby, it is possible to minimize losses that can occur during the process in which the ultrasonic vibrations controlled by the circuit board pcb are transmitted inside the water tank part wt.

Additionally, referring to FIG. 2 together, the charging socket s may be coupled to a charging hole ch formed in one of the body part 10 and the base part 40 and can be connected to the outside of the razor cleaning and maintaining apparatus 1. FIG. 2 shows one embodiment in which the charging hole ch is formed in the base part 40. However, this description is merely illustrative, and the embodiments of the present disclosure are not limited thereto.

Furthermore, the control part 50 may further include an LED indicator led that indicates the operating state of the control part 50 through a color change or lighting signal. For example, a state in which the control part 50 generates ultrasonic vibrations may be displayed in a first color, and a state in which ultrasonic vibration is not generated may be displayed in a second color. However, this is merely an example, and the embodiments are not limited thereto.

In addition, the razor cleaning and maintaining apparatus 1 may further include an LED hole ledh formed in one of the body part 10 and the base part 40 for lighting the LED indicator led.

Next, a cleaning and maintaining method of the razor cleaning and maintaining apparatus 1 will be described with reference to FIG. 16.

FIG. 16 is a diagram for describing a razor cleaning method based on the cross-sectional view of FIG. 1. <e11> in FIG. 16 is a diagram for describing a first cleaning of the razor. <e12> in FIG. 16 is a diagram for describing a second cleaning of the razor.

Referring to <e11> in FIG. 16, the user may proceed with the physical cleaning of the razor blades of the razor ap by bringing the razor ap to be cleaned into contact with the projections pj of the cleaning part 30. Dead skin cells and beard residue left on the razor ap can be first-cleaned by the coupled structure between the cleaning part 30 and the head part 20.

Next, referring to <e12> in FIG. 16, the user may place the razor blades of the first-cleaned razor ap or the razor ap to be cleaned into the liquid w contained in the water tank part wt. For example, the razor cleaning and maintaining apparatus 1 can generate fine bubbles inside the water tank part wt by using ultrasonic vibrations generated by the control part 50. The razor ap can be second-cleaned as the adhered residues are detached while the generated bubbles burst.

As a result, the razor cleaning and maintaining apparatus of the present disclosure can improve the hygiene of the razor blades by first removing the residue on the razor blades with physical cleaning and secondly removing the fine residue and bacteria on the razor blades with non-physical cleaning including ultrasonic waves to hygienically remove the residue on the razor blades, and thereby, can maintain the sharpness of the razor blades for a long time as the cleaning efficiency of the razor increases and can extend the service life of the razor by slowing down the rate of wear and corrosion of the razor blades.

Furthermore, the razor cleaning and maintaining apparatus can effectively protect the skin health of the user by minimizing the risk of skin infection, inflammation, and trouble of the user by completely removing germs, bacteria, and contaminants formed on the razor blades.

Moreover, the razor cleaning and maintaining apparatus can provide the user with the ease of maintaining the razor by minimizing the additional effort of the user for razor maintenance.

While the inventive concept has been particularly shown and described with reference to exemplary embodiments thereof, it will be understood by those of ordinary skill in the art that various changes in form and details may be made therein without departing from the spirit and scope of the inventive concept as defined by the following claims. It is therefore desired that the embodiments be considered in all respects as illustrative and not restrictive, reference being made to the appended claims rather than the foregoing description to indicate the scope of the disclosure.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A razor cleaning and maintaining apparatus, comprising:
a body part in which a central hole is formed to pass through an inside of the body part and which comprises a coupling jaw formed along an inner circumferential surface;
a head part which is coupled to a top of the body part and in which a head hole connected to the central hole and passing through an inside of the head part is formed;
a cleaning part comprising a first outer peripheral surface and a second outer peripheral surface, wherein a plurality of projections are formed on the first outer peripheral surface so as to protrude and the plurality of projections are spaced apart from each other, and the second outer peripheral surface is in close contact with an inner surface of the head part;
a base part coupled to a bottom of the body part;
a water tank part disposed to be housed the inside of the body part and having a protruding part formed to protrude outward from an upper part so as to be caught by the coupling jaw;
a waterproof tape disposed between the coupling jaw of the body part and the protruding part of the water tank part; and
a control part disposed between the base part and the water tank part and configured to control ultrasonic vibrations generated inside the water tank part.

2. The razor cleaning and maintaining apparatus of claim 1, wherein a diameter of a hole defined by the coupling jaw is formed larger than a diameter of the water tank part,
the diameter of the water tank part is formed larger than a lower diameter of the head hole, and
a part of a bottom of the head part is housed inside the water tank part.

3. The razor cleaning and maintaining apparatus of claim 2, wherein the head part comprises a stepped part formed at the bottom of the head part,
the stepped part is coupled to an inner top of the body part and an upper part of the water tank part, and
the protruding part of the water tank part is disposed between the stepped part and the coupling jaw.

4. The razor cleaning and maintaining apparatus of claim 1, wherein the head part comprises a first support part formed in protrusion on the inner surface of the head part in a first direction passing through the inside of the head part, and a second support part formed in protrusion on the inner surface of the head part so as to cover a part of the head hole in a second direction intersecting the first direction, and
the cleaning part comprises a receiving groove formed concavely inward on the second outer peripheral surface in a form that allows coupling to the first support part and the second support part.

5. The razor cleaning and maintaining apparatus of claim 4, wherein the receiving groove comprises a first receiving groove formed in a shape corresponding to an outer shape of the first support part, and a second receiving groove formed in a shape corresponding to an outer shape of the second support part, and
the cleaning part is brought into close contact with an inner circumferential surface of the head part by an external force provided from an outside based on a first coupling between the first support part and the first receiving groove and a second coupling between the second support part and the second receiving groove.

6. The razor cleaning and maintaining apparatus of claim 1, further comprising:
a charging hole formed in one of the body part and the base part,
wherein the control part comprises a battery and a charging socket, and
the charging socket is coupled to the charging hole.

7. A razor cleaning and maintaining apparatus, comprising:
a head part in which a head hole passing through an inside of the head part is formed and which comprises a first support part formed in protrusion on an inner surface of the head part in a first direction passing through the inside of the head part and a second support part formed in protrusion on the inner surface of the head part so as to cover a part of the head hole in a second direction intersecting the first direction;
a cleaning part comprising a first outer peripheral surface and a second outer peripheral surface, wherein a plurality of projections are formed on the first outer peripheral surface so ad to protrude and the plurality of projections are spaced apart from each other and, the second outer peripheral surface is in close contact with the inner surface of the head part, and a receiving groove formed concavely inward on the second outer peripheral surface in a form that allows coupling to the first support part and the second support part; and
a body part coupled to the head part and having a water tank part inside of which ultrasonic waves are generated.

8. The razor cleaning and maintaining apparatus of claim 7, wherein the head hole formed in the head part is formed so that a cross-sectional area gets smaller as the head hole approaches the body part, and
the first outer peripheral surface is formed in a shape of a part of a streamlined shape.

9. The razor cleaning and maintaining apparatus of claim 7, wherein the first support part comprises a plurality of pillars formed on one surface of the second support part and spaced apart from each other, and
each of the pillars is formed to be connected to the inner surface of the head part.

10. The razor cleaning and maintaining apparatus of claim 9, wherein one end of the pillar is connected to the first support part, and the other end of the pillar is formed to have a step relative to a middle part of the pillar.

11. The razor cleaning and maintaining apparatus of claim 7, wherein, the plurality of projections formed on the first outer peripheral surface comprises an upper projection group, a middle projection group and a lower projection group,
the upper projection group disposed in an upper part of the cleaning part and the lower projection group disposed in a lower part of the cleaning part are formed so that a height or thickness is different from each other between adjacent projections, and
the middle projection group disposed in a middle part of the cleaning part is formed so that a height difference or thickness difference between adjacent projections is smaller compared to the upper projection group and the lower projection group.
